(19) United States
(12) Patent Application Publication
(10) Pub. No.: US 2013/0328323 A1
(43) Pub. Date: Dec. 12, 2013

(54) METHOD AND MECHANISM FOR STARTING AN INTERNAL COMBUSTION ENGINE

(71) Applicant: Schaeffler Technologies AG & CO. KG, Herzogenaurach (DE)

(72) Inventors: Wolfgang Reik, Buehl (DE); Thomas Winkler, Offenburg (DE); Mathias Goeckler, Buehl (DE)

(21) Appl. No.: 13/963,504

(22) Filed: Aug. 9, 2013

Related U.S. Application Data
(63) Continuation of application No. PCT/DE2012/000058, filed on Jan. 26, 2012.

(30) Foreign Application Priority Data
Feb. 9, 2011 (DE) 102011010779.7
Mar. 15, 2011 (DE) 102011013996.6

(51) Int. Cl. F02N 11/08

(52) U.S. Cl. CPC F02N 11/08
USPC 290/38 B

(57) ABSTRACT

A method and mechanism for starting an internal combustion engine, having a summed torque extending in a wave form over a rotational angle of the crankshaft of the internal combustion engine, by means of an electric machine which is rotationally coupled to the crankshaft and torsional elasticity which is effective between the crankshaft and the electric machine.

### CROSS-REFERENCE TO RELATED APPLICATIONS

This patent application is filed under 35 U.S.C. §120 and §365(c) as a continuation of PCT International Patent Application No. PCT/DE2012/000058 filed Jan. 26, 2012, which application claims priority from German Patent Application No. 10 2011 010 779.7, filed Feb. 9, 2011, and German Patent Application No. 10 2011 013 996.6, filed Mar. 15, 2011, which applications are incorporated herein by reference in their entireties.

### FIELD OF THE INVENTION

The invention relates to a method and to a mechanism for starting an internal combustion engine, having a summed torque extending in a wave form over a rotational angle of said internal combustion engine, by means of an electric machine which is rotationally coupled to the crankshaft and torsional elasticity which is effective between the crankshaft and the electric machine.

### BACKGROUND OF THE INVENTION

Internal combustion engines, in particular in power trains of motor vehicles, are designed for example as combustion engines having reciprocating or circular pistons. As a result of the movement of the pistons in their cylinders, a summed torque appears over the angle of rotation of the crankshaft which develops in a wave-like pattern due to compression and expansion moments of the gases compressed and expanding in the displacement volume depending on the number of cylinders, and is superimposed by a drag torque formed from moments of friction. During a stoppage of the internal combustion engine, the crankshaft is positioned between two maxima of summed torque by a last expansion process of a cylinder. To be able to successfully execute a starting of the internal combustion engine, the summed torque which follows in the direction of rotation of the crankshaft must be overcome, so that after fuel is injected the internal combustion of the compressed mixture can be ignited and the starting of the internal combustion engine can begin. In order to set the crankshaft in motion, starter motors are employed, which are meshed into a starter ring gear that is connected to the crankshaft. In this case, high reduction ratios of the rotation speeds of the starter motor are effective, which deliver the requisite torque to overcome the summed torque maximum even at high drag torques, which occur for example at low outside temperatures.

In power trains in which the function of the starter motor is integrated into an electric generator, such a high reduction ratio is of little use in generator mode, so that the internal combustion engine must be started at a low reduction ratio. In this case, an electric machine intended for starter and generator operation should be small-dimensioned, for reasons of cost and weight. This can cause difficulties in starting, in particular at high drag torques, which can occur, for example, at low temperatures below 0° C.

### BRIEF SUMMARY OF THE INVENTION

A method and mechanism for starting an internal combustion engine, having a summed torque extending in a wave form over a rotational angle of the crankshaft of said internal combustion engine, by means of an electric machine which is rotationally coupled to the crankshaft and torsional elasticity which is effective between the crankshaft and the electric machine. In order, in particular in the case of large summed torques, to enable the internal combustion engine to be started using an electric machine which has a low step-down ratio relative to the crankshaft or which is optimized for low power levels, at the beginning of a starting process the crankshaft, which is positioned between two wave peaks of the summed torque, is rotated by means of the electric machine through a predefined rotational angle contrary to a direction of rotation of the crankshaft during operation of the internal combustion engine with a smaller summed torque than a maximum summed torque, and the torsional elasticity is pre-tensioned and subsequently accelerated by means of the electric machine while reversing the direction of rotation, in order to overcome the maximum summed torque.

The object of the invention is therefore to propose a method and a mechanism with which reliable starting of the internal combustion engine can be executed in power trains having one electric machine for starting and generator operation.

The object is fulfilled by a method for starting an internal combustion engine having a summed torque extending in a wave form over a rotational angle of said internal combustion engine, by means of an electric machine which is rotationally coupled to the crankshaft and torsional elasticity which is effective between the crankshaft and the electric machine, wherein at the beginning of a starting process the crankshaft, which is positioned between two wave peaks of the summed torque, is rotated by means of the electric machine through a predefined rotational angle contrary to a direction of rotation of the crankshaft during the operation of the internal combustion engine, with a smaller summed torque than a summed torque maximum, and the torsional elasticity is pre-tensioned and subsequently accelerated by means of the electric machine while reversing the direction of rotation, in order to overcome the maximum summed torque. Due to the pre-tensioning of the crankshaft against the torsional elasticity and against the compression of the cylinder of the internal combustion engine which is behind in the angle of rotation, potential energy is built up which supports the electric machine in the actual starting process in the direction of rotation of the crankshaft in normal operation. In this case the stored pressure work of the gas in the compressed cylinder and the spring energy are converted to a torque that supports the torque of the electric machine in the direction of rotation, so that the summed torque maximum of the cylinder being compressed is overcome, although the effective torque of the electric machine acting on the crankshaft is less than the summed torque maximum. Because the drag torque peaks are covered by means of the proposed method, the electric machine can be designed for the normal demands in the usual starting and generator operation, and thus can be of a small and light design.

According to the proposed method, the pre-tensioning of the torsional elasticity and the degree of compression of the prior cylinder and therefore the crankshaft and the torsional elasticity can be loaded with a defined torque of the electric machine. By adjusting the stiffness of the torsional elasticity depending on the compression forces of the prior cylinder, it is possible to provide for avoiding a blocked situation of energy storage devices that form the torsional elasticity. Furthermore, with a rotary linkage of the electric machine to the crankshaft, with allowance for the transmission ratio between them and depending on the number of cylinders of the internal combustion engine, the rotor of the electric machine can be turned by a prescribed angle of rotation, which may be detected, for example, by a rotation angle sensor of the rotor to control the electric machine. In this case, a guideline fir the angle of rotation can be given depending on information about the position in which the crankshaft stands between two summed torque maxima, which is determined, for example, from a value of a rotational speed sensor of the crankshaft which is detected in a control device and is stored even after the internal combustion engine comes to a stop. The preferably electronically commutated electric machine can be operated in an especially advantageous manner with power regulation, using the available variables such as outside temperature, rotational angle of the crankshaft, existing translation ratio and the like, while currently existing summed torques are detected constantly, for example through the demanded power, the flow of current or the like, and are taken into account in controlling the electric machine, both in reverse-turning wind-up operation and in acceleration operation of the crankshaft.

A shiftable gear unit can be positioned effectively between the electric machine and the crankshaft, it being advantageous to shift this gear unit into slow gear from the electric machine to the crankshaft during the switching operation. As a result, the angle of rotation on the electric machine increases and its applicable torque decreases, or the torque acting on the crankshaft rises, so that internal combustion engines having higher summed torque maxima can be started. For example, a starting process of four-cylinder engines, such as diesel engines, succeeds without such a gear unit, using electric machines having a power output of about 8 kW, even at very low outside temperatures below −10° C. Internal combustion engines having even higher load torques at low temperatures, such as 6- to 10-cylinder engines, can be started by means of the same method, using a gear unit shifted to slow, without increasing the power output of the electric machine. In the interest of completeness, let it be noted that the fixed gear ratios i between electric machine and crankshaft in this case can be freely chosen in principle and preferably lie between 2<i<3, and the gear ratio i(g) of the shiftable gear unit can be i(g)>2.5.

According to the inventive concept, the proposed method is confined to situations in which a successful starting process is accelerated by exclusive acceleration of the crankshaft by the electric machine in the direction of operation of the crankshaft, in order to avoid high demands on the material and prolonged starting processes in normal situations. To this end, there can be provision to execute procedures exclusively when expected values for a maximum summed torque of the internal combustion engine are exceeded. Such an expected value can be stored in a control unit as a parameter or characteristic map as a function of relevant parameters, and may be adaptable to long-term and short-term processes. For example, the expected value may be ascertained as a function of the outside temperature, a temperature of the internal combustion engine, the characteristics of the internal combustion engine such as number of cylinders, gas exchange characteristic curves, temperature-dependent load torque, lubricant used and service Alternatively or in addition, the expected value can be adapted constantly by means of present starting processes, for example from the operating data of the electric machine such as power, current and the like, during normal starting processes carried out according to the proposed method.

The object is also fulfilled by a mechanism for carrying out the method. To this end, besides the internal combustion engine with a crankshaft and the electric machine that can be connected to it in a rotationally fixed connection, a control unit is provided in the mechanism in which the routines for carrying out the method are stored and processed. Furthermore, the mechanism has a spring device of a vibration damping device which is connected to the crankshaft in a rotationally fixed connection, which is used as torsional elasticity in the proposed method. In this case, the vibration damping device can be positioned in series or parallel with the electric machine. For example, the vibration damping device can be positioned effectively in series in the power path between electric machine and crankshaft, or between crankshaft and another component, for example a transmission input shaft. The characteristic curve of the spring device in this case may be linear or degressive or progressive. For the purposes of positive acceleration behavior, and thus of forming a high angular momentum of the electric machine, it has proven advantageous for the spring device to have a clearance angle of for example, up to ±30°, so that after the pre-tensioning of the spring device which promotes acceleration of the electric machine has decreased, a force-free range of the spring device is in effect, and the summed torque maximum is essentially reached before the spring device builds up a spring moment again in the opposite direction. A spring device, in the meaning of the invention, means a device which is suitable for reversible storing and emission of potential energy as a function of its torsional angle. In addition to the preferred use of metal elements, such as coil springs, diaphragm spring packages and the like, elastomeric elements and other non-metallic energy storage devices may also be provided.

In a preferred exemplary embodiment, the electric machine which is used as a starter-generator and possibly for stationary air conditioning is included in a belt drive of the internal combustion engine, in which the spring device of a vibration damping device supplies the torsional elasticity as a belt damping device. Such belt damping devices are able to damp torsional vibrations of the crankshaft and/or vibrations of the belt, and are themselves familiar as pulley dampers, belt tensioners as well as pendulum tensioners, decouplers, viscous dampers or the like. According to the invention, the function of the spring device of these belt damping devices is used as torsional elasticity for the proposed method. For effective use of the torsional elasticity, a torsional angle of the latter may be especially large, for example up to ±90°.

In another exemplary embodiment of the mechanism, the electric machine may be placed in a hybrid arrangement, where it is preferably connectible to a transmission input shaft of a transmission, parallel to the internal combustion engine. In order to damp torsional vibrations of the crankshaft due to combustion processes that take place cyclically non-uniformly over the angle of rotation, an appropriate vibration damping device in the form of a torsional vibration damper may be provided, having a spring device such as a dual mass flywheel effectively situated between crankshaft and transmission input shaft, and thus between crankshaft and electric machine. When starting the internal combustion engine according to the proposed method, the electric machine tightens the spring device against the running direction of the crankshaft, and uses the potential energy stored in it along with the accumulating expansion moment of the previously compressed cylinder for the starting process in the running direction. If a so-called hybrid coupling is provided between the electric machine and the internal combustion engine in a hybrid power train, because of the support of the compression forces and of the spring device the hybrid coupling can be designed appropriately for smaller torques, at least during a cold start, since it does not need to cover the high starting torques during a cold start phase.

The mechanism provides a shiftable gear unit positioned between electric machine and crankshaft, in particular in the arrangement of the electric machine in the belt drive, which supports the electric machine while providing (additional) reduction of the electric machine to slow gear during the preceding tightening process and the starting process.

### BRIEF DESCRIPTION OF THE DRAWINGS

The invention will be explained in greater detail on the basis of FIGS. 1 and 2. The figures show the following:

FIG. 1 is a schematic depiction of a mechanism for starting an internal combustion engine; and,

FIG. 2 is a torque pattern of an internal combustion engine through a crankshaft angle to explain the starting method.

### DETAILED DESCRIPTION OF THE INVENTION

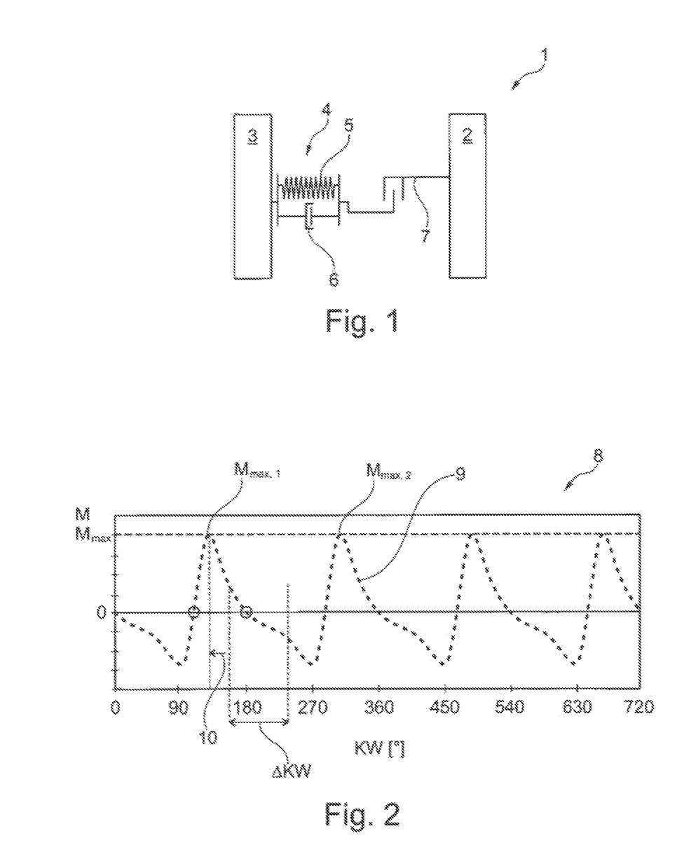

FIG. 1 shows a schematic diagram of mechanism 1 with internal combustion engine 2 and electric machine 3, which are connected together in a rotationally fixed connection with vibration damping device 4 interposed. Vibration damping device 4 includes spring device 5 and friction device 6. Electric machine 3 can be operated in both directions, and to that end is commutated for example electronically. Internal combustion engine 2 is preferably a combustion engine with a plurality of cylinders, for example 4 to 12. The electric machine can be situated in a hybrid power train in the pulley plane or parallel to the internal combustion engine 2, and connected to the crankshaft directly or by means of an appropriate releasable connection such as a decoupling clutch. Accordingly, the vibration damping device is employed as a pulley damper, decoupler or belt tensioner, or as a dual mass flywheel, during operation of internal combustion engine 2.

When internal combustion engine 2 is not running, to start it at high summed torques, in a preconditioning phase electric machine 3 is rotated contrary to its running direction during the operation of the internal combustion engine 2 in generator, boost or recuperation mode or a normal start, so that spring device 5 is compressed. The spring moment which is present in this case is held intact by crankshaft 7, while compression moments of the cylinder (or cylinders, if more than one are present) currently sealed by means of the valves of internal combustion engine 2 are in operation, and the contents of the affected cylinder or cylinders are compressed, whereby compression work is stored in the cylinders and potential energy is stored in spring device 5. When the direction of rotation of the electric machine 3 is reversed, the power applied to it is supported by the released expansion forces of the cylinder or cylinders and the relaxation forces of spring device 5, so that the latter, by means of increased angular momentum, overcomes the summed torque of the cylinder which is compressed at greater angles of rotation of crankshaft 7, and the fuel that is injected into this cylinder is brought to ignition and internal combustion engine 2 is thereby started.

FIG. 2 shows, in reference to mechanism 1 of FIG. 1, diagram 8 of the summed torque M of internal combustion engine 2 against the angle of rotation KW of crankshaft 7, on the basis of a four-cylinder engine. Evenly distributed over two revolutions of crankshaft 7, corresponding to an angle of rotation of 720°, each of the cylinders is compressed and relaxed one after the other, so that over the angle of rotation the summed torque pattern 9 torque pattern 9 with four summed torque maxima Mₘₐₓ results. Summed torque pattern 9 is formed here from the compression and expansion moments of the cylinders and the drag moments of the pistons in the cylinders, the bearing friction of the connecting rods and of the crankshaft and auxiliary shafts and the like.

If internal combustion engine 2 is brought to a stop, crankshaft 7 settles around the zero point of summed torque pattern 9 between two summed torque maxima M_{max,1}, M_{max,2} in rotational angle range ΔKW, which may differ from the zero point due to the drag moments present and may be detected precisely by a rotational angle sensor of crankshaft 7.

If, based on an evaluation of an expected value determined, for example, from the outside temperature, a summed torque M of the summed torque maximum M_{max,2} to be overcome during a start is found to be greater than a torque that can be delivered by electric machine 3, electric machine 3 may be fed current contrary to its original direction of operation, using the exact position of the crankshaft, so that crankshaft 7 is rotated contrary to its original direction of operation in the direction of arrow 10. Based on the expected value, the information about the rotational angle of the crankshaft, the moment present on electric machine 3 and/or other appropriate variables, crankshaft 7 is rotated up to no higher than the upper dead point of the cylinder with the summed torque maximum M_{max,1}, so that with a reversal of direction of electric machine 3 due to the expansion moment the pre-tensioned spring device 5 is released, and the summed torque maximum M_{max,2} which is elevated at outside temperatures, for example lower than 0°, is overcome and internal combustion engine 2 is started.

### REFERENCE VARIABLES

1 mechanism
2 internal combustion engine
3 electric machine
4 vibration damping device
5 spring device
6 friction device
7 crankshaft
8 diagram
9 summed torque pattern
10 arrow
ΔKW rotational angle range
KW angle of rotation of crankshaft
M summed torque
Mₘₐₓ summed torque maximum
M_{max,1} summed torque maximum
M_{max,2} summed torque maximum

What is claimed is:

1. A method for starting an internal combustion engine (2) having a summed torque (M) extending in a wave form over a rotational angle (KW) of the crankshaft (7) of said internal combustion engine, by means of an electric machine (3) which is rotationally coupled to the crankshaft (7) and torsional elasticity which is effective between the crankshaft (7) and the electric machine (3), wherein at the beginning of a starting process the crankshaft (7), which is positioned between two summed torque maxima (M_{max,1}, M_{max,2}), is rotated by means of the electric machine (3) through a predefined rotational angle contrary to a direction of rotation of the crankshaft (7) during the operation of the internal combustion engine (2) with a smaller summed torque (M) than a maximum summed torque (M_{max,1}), and the torsional elasticity is pre-tensioned and subsequently accelerated by means of the electric machine (3) while reversing the direction of rotation, in order to overcome the maximum summed torque (Mₘₐₓ).

2. The method recited in claim 1, wherein the crankshaft (7) and the torsional elasticity are loaded with a predefined torque of the electric machine (3).

3. The method recited in claim 1, wherein the crankshaft (7) is adjusted by a predefined angle of rotation as a function of a transmission ratio set between electric machine (3) and crankshaft (7) and a number of cylinders of the internal combustion engine (2).

4. The method recited in claim 1, wherein a shiftable gear unit which may be present between electric machine (3) and crankshaft (7) is shifted into slow gear ratio from the electric machine (3) to the crankshaft (7).

5. The method recited in claim 1, wherein the method is carried out when an expected value for a maximum summed torque (Mₘₐₓ) of the internal combustion engine (2) is exceeded.

6. The method recited in claim 5, wherein the expected value is determined as a function of the outside temperature.

7. A mechanism (1) for carrying out the method recited in claim 1, comprising a control unit to store program routines for carrying out the method, wherein, torsional elasticity is provided as a spring device (5) of a vibration damping device (4).

8. The mechanism (1) recited in claim 7, wherein the electric machine (3) is included in a belt drive and the spring device (5) is a belt damping device.

9. The mechanism (1) recited in claim 8, wherein a shiftable gear unit is positioned between the electric machine (3) and the crankshaft (7).

10. The mechanism (1) recited in claim 7, wherein the electric machine (3) is situated parallel to the internal combustion engine (2) in a hybrid power train, and the spring device (5) is part of a torsional vibration damper.
